(19) United States
(12) Patent Application Publication
(10) Pub. No.: US 2008/0147479 A1
(43) Pub. Date: Jun. 19, 2008

(54) Proprietor currency assignment system and method

(75) Inventor: Brian Johnson, Campbell, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/641,262

(22) Filed: Dec. 19, 2006

(51) Int. Cl. G06Q 30/00; G06F 17/30

(52) U.S. Cl. 705/10; 705/26

(57) ABSTRACT

A method and a system assign a proprietary currency value to goods to be bartered, the proprietary currency value linked to the current pricing of the goods. For example, an offered listing of goods to be bartered may be received from a first user. A currency converter module may access a database containing online marketplace data relating to the current pricing of goods and may assign a proprietary currency value to the goods of the offered listing to be bartered based on the current pricing of the goods.

### TECHNICAL FIELD

The present application relates generally to the technical field of data-processing and, in one specific example, to a method and system to assign a proprietary currency value to goods to be bartered, the proprietary currency value linked to the current pricing of the goods.

### BACKGROUND

Various online barter systems are available to barter different types of goods. For example, a number of online marketplaces specialize in the barter of secondhand CD's, DVD's and books. These online marketplaces facilitate an environment where potential sellers list the goods to be bartered and potential buyers list desired goods. Whenever a match is identified between offered goods and desired goods, the potential buyer and seller exchange the goods (e.g., via the postal system) and associated accounts of the buyer and seller are credited and debited with the “value” of the goods.

In current barter systems, a proprietary currency value or “points” may be assigned to the goods to be bartered in accordance with various rules defined by the barter systems. For example, the rules may specify that new release CD's of DVD's are to be assigned high proprietary currency values, and additionally, that high demand goods where low supply is available are to be assigned high proprietary currency values. Goods in high supply but low demand should also, for example, be assigned low proprietary currency values.

These systems may be difficult to manage, especially as the update of proprietary currency values may be a manual and complicated process, having to take into account various rules and market conditions.

### BRIEF DESCRIPTION OF THE DRAWINGS

Some embodiments are illustrated by way of example and not limitation in the figures of the accompanying drawings in which:

FIG. 1 is a block diagram illustrating a system to implement a method for assigning a proprietary currency value to goods to be bartered, the proprietary currency value linked to the current pricing of the goods, in accordance with an example embodiment;

FIG. 2 is a block diagram illustrating multiple modules that, in one example embodiment, form part of the system of FIG. 1;

FIG. 3 is a block diagram illustrating the data architecture of information stored in databases in accordance with the example embodiment of FIG. 1;

FIG. 4 is a simplified flow diagram of a method for assigning a proprietary currency value to goods to be bartered, the proprietary currency value linked to the current pricing of the goods, in accordance with an example embodiment;

FIGS. 5 and 6 show a further flow diagram of the method for assigning a proprietary currency value to goods to be bartered shown in FIG. 4, in accordance with an example embodiment; and

FIG. 7 is a block diagram showing a machine for performing any one of the example methods described herein.

### DETAILED DESCRIPTION

Example methods and systems to assign a proprietary currency value to goods to be bartered, the proprietary currency value linked to the current pricing of the goods, are described. In the following description, for purposes of explanation, numerous specific details are set forth in order to provide a thorough understanding of example embodiments. It will be evident, however, to one skilled in the art that the present invention may be practiced without these specific details.

The example methods and systems provide for a process where a potential seller in a barter transaction, e.g., a person who wants to exchange a number of CD's or DVD's with other people, lists the goods to be bartered on a barter website. A potential buyer may also list the goods he would like to receive on the barter website. Once a match has occurred between the goods offered by the potential seller and the goods desired by the potential buyer, the process assists the potential buyer and seller to exchange the goods, e.g., with the seller sending the goods by post to the buyer. However, to reflect this exchange in financial terms, barter accounts of the seller and buyer will be credited and debited.

In order to determine a value for the goods bartered in the system, a proprietary currency value or “points” will be assigned to each of the goods listed either by the potential buyer or by the potential seller. This assigned value will be obtained by accessing an information database that holds information on the current pricing of the goods to be bartered. For example, the barter system may access another online marketplace, such as an auction website (e.g., eBay.com) or a fixed-price website (e.g., Half.com), to obtain the current value of any particular goods as transacted in these online environments. It will be appreciated that the barter system may in certain circumstances access a database with such current pricing maintained by the barter system itself. In these circumstances, the barter system may access various external databases to maintain the internal database. Alternatively, the database may be maintained by an external marketplace and may only be accessed by the barter system. It will also be appreciated that the barter system may, but need not, form part of another online marketplace.

By linking the proprietary currency value of the goods to be bartered with the current pricing of such goods, one example benefit may be that the maintenance of the proprietary currency value of the goods is automatic, up to date and easy to maintain.

### Platform Architecture

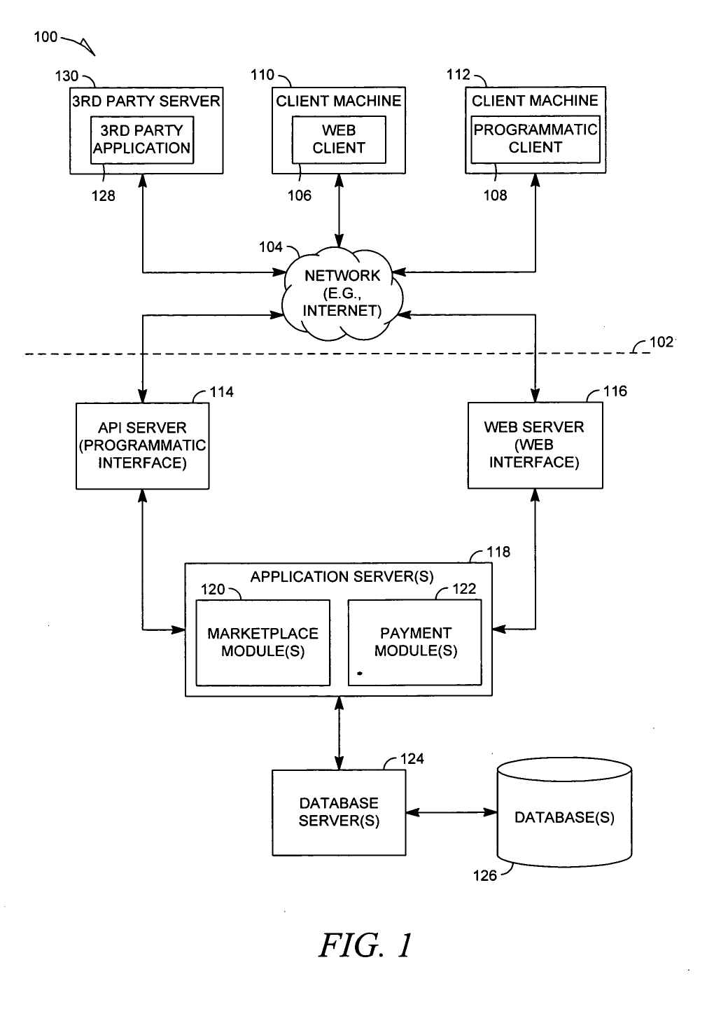

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. As will be described in more detail below, the networked system 102 may relate to a barter system for goods that may, but need not, form part of an auction and/or fixed-price system. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace modules 120 and may also host payment modules 122. The application servers 118 are, in turn, shown to be coupled to one or more databases servers 124 that facilitate access to one or more databases 126.

The marketplace modules 120 may provide a number of marketplace functions and services to users that access the networked system 102. For example, barter, auction and/or fixed-price services may be provided. The payment modules 122 may likewise provide a number of payment services and functions to users. The payment modules 122 may allow users to accumulate value (e.g., in a commercial currency, such as the U.S. dollar, or a proprietary currency, such as “points”) in accounts, and then later to redeem the accumulated value for products (e.g., goods) that are made available via the marketplace modules 120. As will be described in more detail below, the commercial currency value of goods transacted in the auction and/or fixed price systems may be used to determine the proprietary currency value of goods to be bartered in the barter system. While the marketplace and payment modules 120 and 122 are shown in FIG. 1 to both form part of the networked system 102, it will be appreciated that, in alternative embodiments, the payment modules 122 or parts thereof may form part of a payment service that is separate and distinct from the networked system 102.

Further, while the system 100 shown in FIG. 1 employs a client-server architecture, the interpretation of the present disclosure is not to be limited to such an architecture, and could equally well find application in a distributed, or peer-to-peer, architecture system, for example. The various marketplace and payment modules 120 and 122 could also be implemented as standalone modules or software programs, which do not necessarily have networking capabilities.

The web client 106 accesses the various marketplace and payment modules 120 and 122 via the web interface supported by the web server 116. Similarly, the programmatic client 108 accesses the various services and functions provided by the marketplace and payment modules 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

### Marketplace Applications

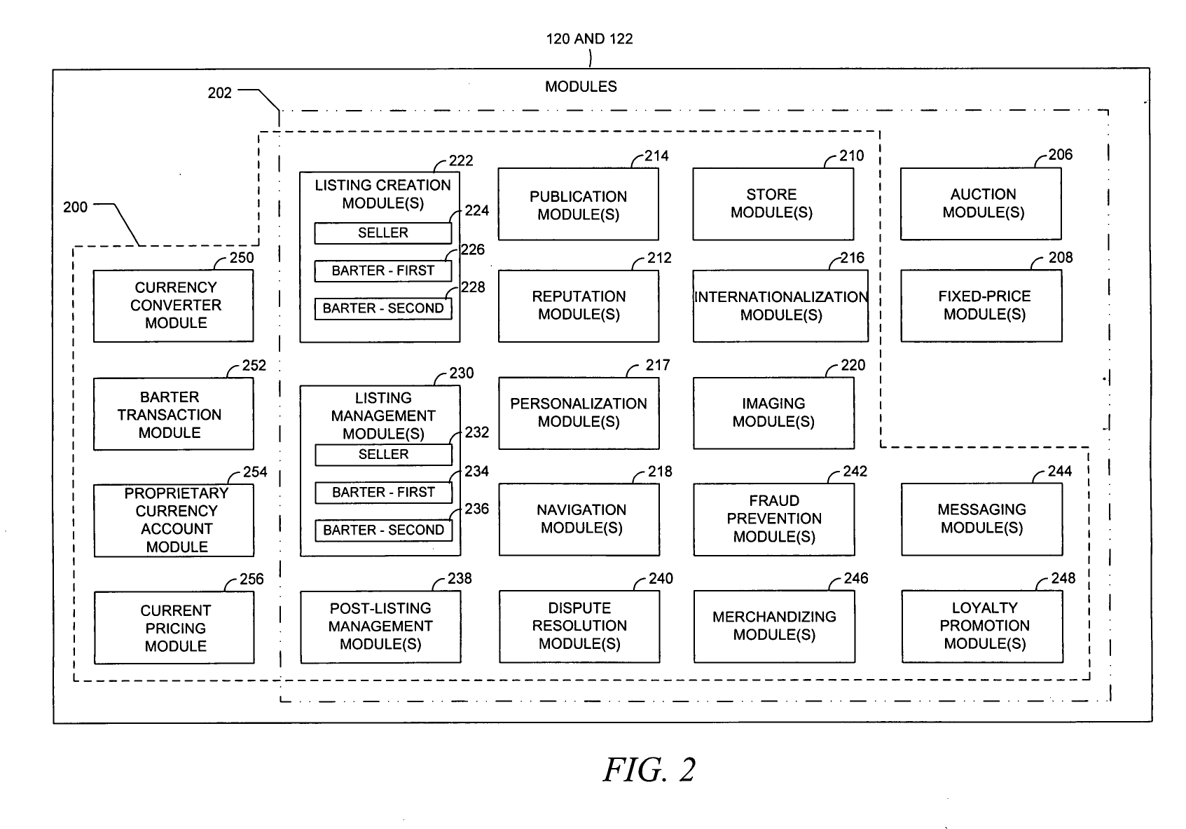

FIG. 2 is a block diagram illustrating multiple modules 120 and 122 that, in one example embodiment, are provided as part of the networked system 102. The modules 120, which may be applications in certain example embodiments, may be hosted on dedicated or shared server machines (not shown) that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules may furthermore access one or more databases 126 via the database servers 124.

The networked system 102 may provide a number of publishing, listing and price-setting mechanisms whereby users may list goods to be offered for sale or barter, and users may indicate a desire to buy goods so offered. For example, a first user or potential seller may list (or publish information concerning) goods offered for barter, a second user or potential buyer can express interest in or indicate a desire to obtain such goods, or alternatively, may list (or publish information concerning) goods to be obtained from bartering. A price may be determined in a proprietary currency for a transaction pertaining to the goods to be bartered. To this end, the marketplace modules 120 are shown to include at least one publication module 214.

In embodiments, as shown by FIG. 2, where the networked system 102 relates to a barter system 200 that forms part of an auction and/or fixed-price system 202, various modules of the networked system 102 may share functionality between the barter system 200 and the auction and/or fixed price system 202, while other modules may provide only functionality to either the barter system 200 and the auction and/or fixed price system 202. It will however be appreciated that the barter system 200 may function independently, on its own, and not as part of the auction and/or fixed price system 202.

The barter system 200 may include one or more modules which support the barter of goods according to a proprietary currency. The various barter modules may also provide a number of features in support of such barter-format listings, assignment of proprietary currency values etc.

One or more auction modules 206 support auction-format listing and price setting mechanisms (e.g., English, Dutch, Vickrey, Chinese, Double, Reverse auctions etc.). The various auction modules 206 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price modules 208 support fixed-price listing formats (e.g., the traditional classified advertisement-type listing or a catalogue listing) and buyout-type listings. Specifically, buyout-type listings (e.g., including the Buy-It-Now (BIN) technology of eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store modules 210 allow a first user who offers a listing of goods to be bartered or a second user who desires a listing of goods, or alternatively, a seller to group listings within a “virtual” store, which may be branded and otherwise personalized by and for the users. Such a virtual store may also offer promotions, incentives and features that are specific and personalized to a relevant seller, in particular for the auction and fixed-price modules.

Reputation modules 212 allow users that transact, utilizing the networked system 102, to establish, build and maintain reputations, which may be made available and published to potential trading partners. Consider that where, for example, the networked system 102 supports person-to-person trading (e.g., in barter systems), users may otherwise have no history or other reference information whereby the trustworthiness and credibility of potential trading partners may be assessed. The reputation modules 212 allow a user, for example through feedback provided by other transaction partners, to establish a reputation within the networked system 102 over time. Other potential trading partners may then reference such a reputation for the purposes of assessing credibility and trustworthiness. It will be appreciated that reputation data may be shared by the barter system 200 and the auction and fixed-price systems 202. For example, where a particular user has built a reputation as a reputable seller on the auction system 202, this information may be used to establish the seller as a potential reputable user of the barter system 200.

Personalization modules 217 allow users of the networked system 102 to personalize various aspects of their interactions with the networked system 102. For example a user may, utilizing an appropriate personalization module 217, create a personalized reference page at which information regarding transactions to which the user is (or has been) a party may be viewed. Further, a personalization module 217 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States or various regions of the United States. Each of these versions may operate as an independent marketplace, or may be customized (or internationalized) presentations of a common underlying marketplace. The networked system 102 may accordingly include a number of internationalization module 216 that customize information (and/or the presentation of information) by the networked system 102 according to predetermined criteria (e.g., geographic, demographic or marketplace criteria). For example, the internationalization module 216 may be used to support the customization of information for a number of regional websites that are operated by the networked system 102 and that are accessible via respective web servers 116.

Navigation of the networked system 102 may be facilitated by one or more navigation modules 218. For example, a search application (as an example of a navigation module) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace modules 120 may include one or more imaging modules 220 utilizing which users may upload images for inclusion within listings. An imaging module 220 also operates to incorporate images within viewed listings. The imaging modules 220 may also support one or more promotional features, such as image galleries that are presented to potential buyers, e.g., by the auction or fixed-price modules 206 and 208. For example, sellers may pay an additional fee to have an image included within a gallery of images for promoted items.

Listing creation modules 222 allow sellers or users of the barter system 200 conveniently to author listings pertaining to goods or services that they wish to transact via the networked system 102. As shown in FIG. 2, the listing creation modules may comprise sub-modules 224, 226 and 228 to manage the listings pertaining to sellers and the different users of the barter system 200. The seller listing creation module 224 is to manage the listings of sellers in the auction or fixed-price system 202. A first listing creation module 226 is to receive from a first user (e.g., a potential barter seller) an offered listing of goods to be bartered. Similarly, a second listing creation module 228 is to receive from a second user (e.g., a potential buyer of bartered goods) a desired listing of goods.

Listing management modules 230 allow for the management of such listings. The listing management modules 230 also comprises a number of sub-modules, e.g., a seller listing management module 232 and first and second listing management modules 234 and 236 to manage the listings of goods relating to the barter system 200.

For example, in the case of the auction and fixed-price systems 202, the management of listings of the seller listing creation module 224 may present a challenge where a particular seller has authored and/or published a large number of listings. The seller listing management module 232 may provide a number of features (e.g., auto-relisting, inventory level monitors, etc.) to assist the seller in managing such listings.

The first and second listing management modules 234 and 236 may have similar functionality to allow users to manage their listings. The first listing management module 234 is to determine whether a proprietary currency value assigned to the goods of the offered listing complies with one or more threshold value criteria. In some embodiment, the first listing management module 234 is to determine whether the proprietary currency value is equal to or above a predefined minimum value, and/or equal to or lesser than a predefined maximum value. The process of assigning the proprietary currency value is described in more detail below. In the event that the proprietary currency value of the goods is below a predefined minimum value, the first listing management module 234 is to reject goods of the offered listing received from the first user. In contrast, in the event that the proprietary currency value of the goods is equal to or above the predefined minimum value, the first listing management module 234 is to accept goods of the offered listing received from the first user. This ensures that users offering goods for barter do not flood the networked system 102 with goods of little or no value.

The second listing management module 236 is to determine whether the proprietary currency value assigned to the goods of the desired listing is equal to or above a proprietary currency value in a proprietary currency account of the second user. If the proprietary currency value in the proprietary currency account of the second user is not sufficient, the second user may not be allowed to transact in a barter transaction.

One or more post-listing management modules 238 also assist sellers or users with a number of activities that typically occur post-listing. For example, upon completion of an auction facilitated by one or more auction modules 206, or on completion of a barter facilitated by one or more of the modules of the barter system 202, a user may wish to leave feedback regarding a particular buyer. To this end, a post-listing management module 238 may provide an interface to one or more reputation modules 212, so as to allow the user conveniently to provide feedback regarding multiple buyers or any other user to the reputation module 212.

Dispute resolution modules 240 provide mechanisms whereby disputes arising between transacting parties may be resolved. For example, the dispute resolution modules 240 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention modules 242 implement fraud detection and prevention mechanisms to reduce the occurrence of fraud within the networked system 102.

Messaging modules 244 are responsible for the generation and delivery of messages to users of the networked system 102, such messages for example advising users regarding the status of listings at the networked system 102 (e.g., providing “outbid” notices to bidders during an auction process, to provide matching information to the users in a barter process, or to provide promotional and merchandising information to users). Respective messaging modules 244 may utilize any one have a number of message delivery networks and platforms to deliver messages to users. For example, messaging modules 244 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising modules 246 support various merchandising functions that are made available to sellers to enable sellers to increase sales via the networked system 102. The merchandising modules 246 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions modules 248. For example, a buyer may earn loyalty or promotions points for each transaction established and/or concluded with a particular seller, and be offered a reward for which accumulated loyalty points can be redeemed.

The multiple modules 120 and 122 relating to the auction and fixed-price system 202 generates a current pricing of goods transacted in the marketplace, e.g., in an online market place. This current pricing of goods may be stored in one of the tables maintained in the databases 126 shown in FIG. 1.

A currency converter module 250 provides support to the barter system 200 and is configured to access the database containing the current pricing of goods to obtain a current pricing of the goods on the offered listing to be bartered. The currency converter module 250 is to assign a proprietary currency value to the goods on the offered listing based on the current pricing of the goods.

The proprietary currency and its associated value in terms of commercial currencies are determined by the proprietary of the barter system and would, for example, associate a commercial currency value (e.g., the US dollar) with a predetermined amount of “points” or “barter money”. For example, every $2 may be equivalent to 1 proprietary currency value or point, with $12 equating to 6 points. Different rules may apply to this conversion, e.g., commercial currency values may be rounded down to the nearest equal number. Alternatively, every 1 cent may be equivalent to 1 proprietary currency value or “point”, with $5.05 then being equal to 505 proprietary currency value or “points”.

The currency converter module 250 is to access the database containing the current pricing of goods periodically to obtain an updated current pricing of the goods on the offered listing to be bartered and to assign an updated proprietary currency value to the goods on the offered listing based on the current pricing of the goods. The periodic updating of the proprietary currency value is beneficial, as goods may be on an offering listing for an indefinite period of time. By updating the proprietary currency value periodically, the barter system 200 remains up to date with the current pricing of goods. The periodic update of the proprietary currency value may be preset by the system, e.g., updates may be performed in near real-time, at second intervals, minute intervals or at hour intervals, or on a daily, weekly or monthly basis. In an example embodiment, currency converter module 250 may the database in the near real-time to obtain the updated current pricing of the goods on the offered listing to be bartered and generate the updated current pricing based on auction pricing (e.g., real-time) on an online marketplace.

The currency converter module 250 may also update the proprietary currency value of goods at the time of transacting on the goods, e.g., when the offered goods and desired goods are matched.

Prior to crediting or debiting the proprietary currency accounts (described in more detail below), the currency converter module 250 may adjust the assigned proprietary currency value for the matched goods, based on at least one of a group of conditions. These conditions may be a condition of the goods to be bartered, a location of the goods to be bartered, profile data of the first user (the potential seller) or a time-to-ship period associated with the first user. This information is to be obtained from the various modules 120 and 122 relating to both the barter system 200 and the auction and fixed-price system 202.

A barter transaction module 252 forms part of the barter system 200 and is configured to match goods of the offered listing received from the first user (potential seller) to goods of the desired listing received from the second user (potential buyer). In the event that the first listing management module 234 has to accept goods as having a proprietary currency value above a predetermined value, the barter transaction module 252 would only match the goods after such acceptance.

A proprietary currency account module 254 maintains proprietary currency accounts of users of the barter system. The proprietary currency accounts would typically only comprise a proprietary currency value and not a commercial currency value. In order to commence transacting in the barter system 200, a user may first need to offer a number of goods to be bartered. Each of the goods would then be assigned a proprietary currency value and these values would be listed in the proprietary currency account of the user. The proprietary currency account module 254 is to credit the proprietary currency account of the first user and debit the proprietary currency account of the second user with the proprietary currency value assigned to the matched goods by the currency converter module 250.

A current pricing module 256, may, in certain embodiments, be configured to determine current pricing of goods from available auction or fixed price transactions. For example, the current pricing module 356 may extract all the prices of goods on offer on the barter system 200 from pricing structures of the auction and/or fixed-priced systems and may, on a continuous basis, calculate the current pricing of these goods.

### Data Structures

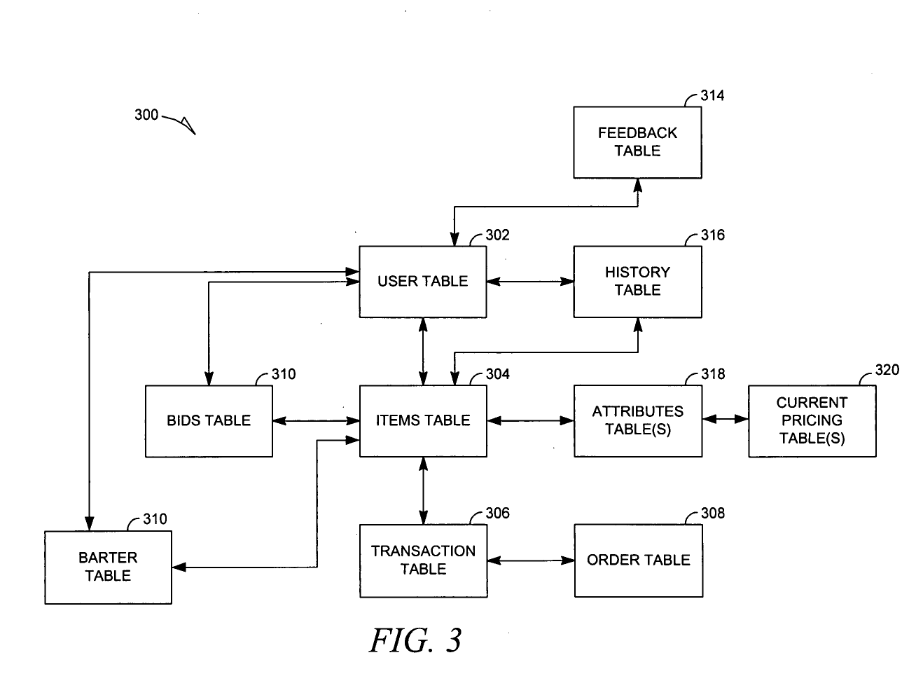

FIG. 3 is a high-level entity-relationship diagram, illustrating various tables 300 that may be maintained within the databases 126, and that are utilized by and support the modules 120 and 122. A user table 302 contains a record for each registered user of the networked system 102, and may include identifier, address and financial instrument information pertaining to each such registered user. A user may operate as a seller, a buyer, a barter user (e.g., a first user offering goods to be bartered (e.g., a potential seller) or a second user desiring goods to be bartered (e.g., a potential buyer) or any combination of these types of users, within the networked system 102. In one example embodiment, a buyer or second user may be a user that has accumulated value (e.g., commercial or proprietary currency), and is accordingly able to exchange the accumulated value for items that are offered for sale by the networked system 102.

It should be noted that the timing of the exchange of value (e.g., the exchange of currency for items) may vary. For example, a first party may send an item to a second party, and the second party may then transfer an appropriate currency value to the first party upon receipt of the item. Alternatively, the second party may transfer the appropriate currency value, upon receipt of which the first party may send the item to the first party. In yet a further scenario, the first and second parties may exchange the item and the currency value simultaneously.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller or barter user and one or more actual or potential buyers or barter users with each item record.

A transaction table 306 contains a record for each transaction (e.g., a purchase, sale transaction or barter transaction) pertaining to items for which records exist within the items table 304.

An order table 308 is populated with order records, each order record being associated with an order. Each order, in turn, may be with respect to one or more transactions for which records exist within the transaction table 306.

Bid records within a bids table 310 each relate to a bid received at the networked system 102 in connection with an auction-format listing supported by an auction module 206. Barter records within a barter table 312 each relate to a barter received at the networked system 102 in connection with a barter listing, e.g., goods of the offered listing to be bartered or goods of the desired listing, supported by the modules of the barter system 200.

A feedback table 314 is utilized by one or more reputation modules 212, in one example embodiment, to construct and maintain reputation information concerning users. A history table 316 maintains a history of transactions to which a user has been a party. One or more attributes tables 318 record attribute information pertaining to items for which records exist within the items table 304. Considering only a single example of such an attribute, the attributes tables 318 may indicate a currency attribute associated with a particular item, the currency attribute identifying the currency of a price for the relevant item as specified in by a seller.

A current pricing table 320 maintains the current pricing of goods transacted in the marketplace, e.g., in an online market place. The current pricing table 320 maintains this information by accessing the attributes table 318 and extracting information on all goods being transacted by the auction or fixed price systems 202. For example, in the case where the barter system 200 relates to CD's or DVD's, the current pricing module 256 may extract all the prices of CD's and DVD's from the attributes table 318 and may, on a continuous basis, calculate the current pricing of these CD's and DVD's. This current pricing is stored in the current pricing table 320 and accessed to determine a proprietary currency value for goods to be bartered.

### Flowcharts

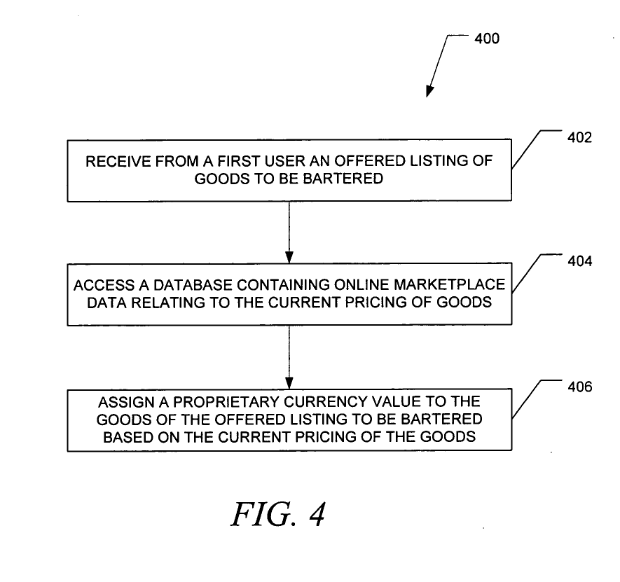

FIG. 4 shows a simplified flow diagram of a method 400 for assigning a proprietary currency value to goods to be bartered, the proprietary currency value linked to the current pricing of the goods. In one example embodiment of the invention, the method may be implemented by the system of FIG. 1.

Turning to block 402, an offered listing of goods to be bartered is received by a first listing creation module 226. The goods may, for example, be a number of CD's or DVD's which the first user has already watched and now wants to exchange for different CD's or DVD's.

A currency converter module 250 may access a database 126 containing online marketplace data relating to the current pricing of goods (shown by block 404). As described above, a current pricing table 320 may be maintained in the database 126 and may keep up to date records of the current pricing of goods auctioned or sold in an online auction and/or fixed-price system 202.

The currency converter module 250 assigns, as shown by block 406, a proprietary currency value to the goods of the offered listing to be bartered based on the current pricing of the goods. In one example embodiment, the conversion between the current pricing and proprietary currency may be 2:1. The currency converter module 250 may then, for example, access the database 126, and in particular the current pricing table 320 maintained in the database 126, and may determine that a specific DVD has a current pricing of $16 as determined by the online auction and/or fixed-price system 202. The currency converter module 250 converts the $16 to 8 proprietary currency “points” and this is the proprietary currency value that the first user will accumulate in the user's proprietary currency account for offering the particular DVD for bartering. If the DVD to be offered was old and not in demand, the current pricing for the DVD may have been determined as $6, equating to 3 proprietary currency points.

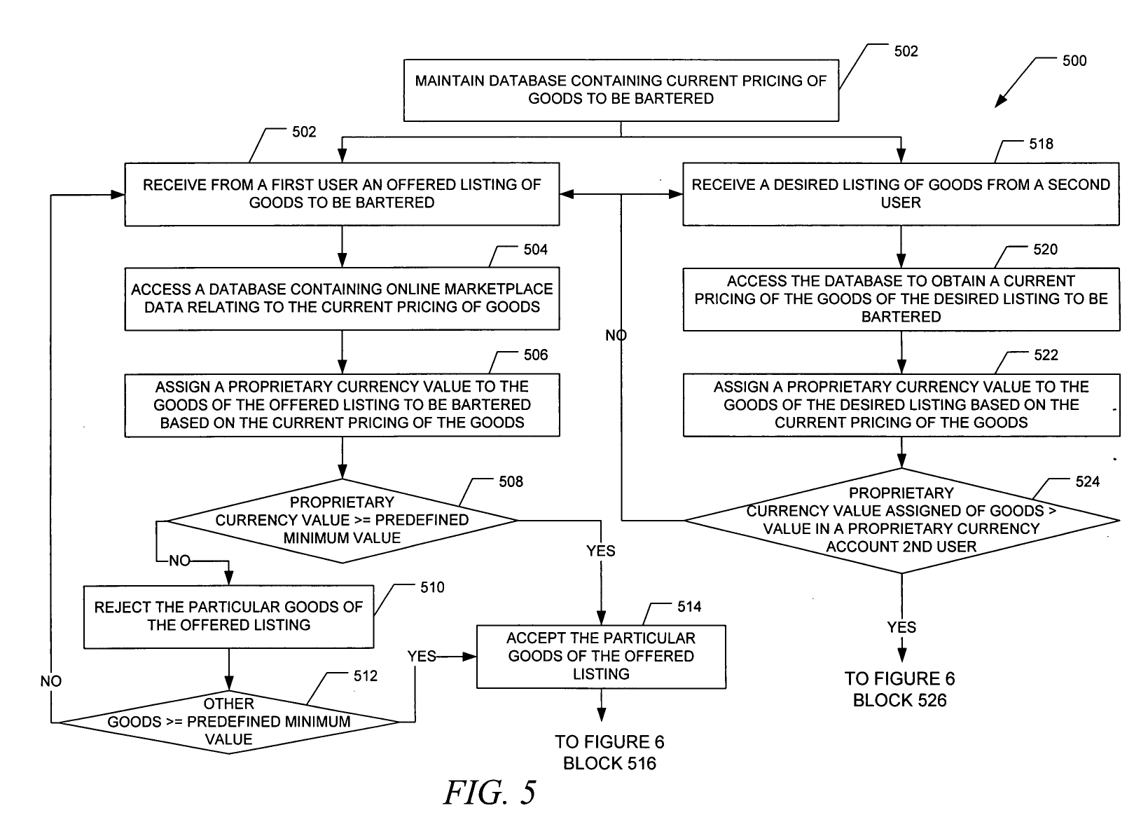

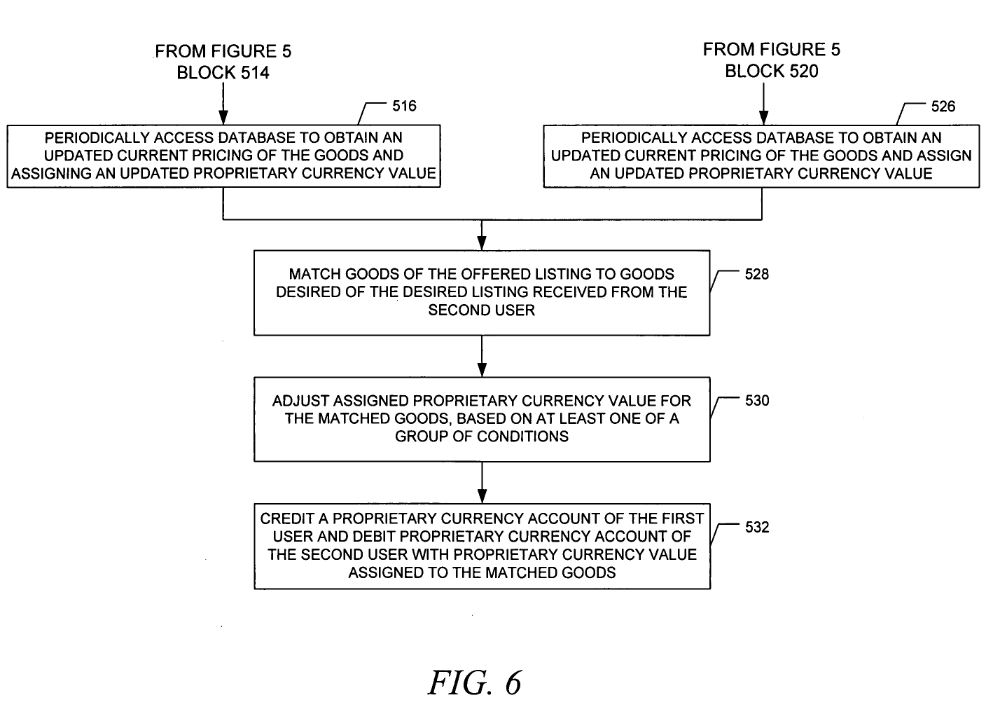

FIGS. 5 and 6 show a more detailed flow diagram of a method 500 for assigning a proprietary currency value to goods to be bartered, the proprietary currency value linked to the current pricing of the goods, in accordance with an example embodiment. This method may also, in an example embodiment, be implemented by the system of FIG. 1.

As shown by block 502 a database 126, e.g., a current pricing table 320 in the database 126, is maintained containing the current pricing of goods to be bartered. As described, this current pricing table 320 may be maintained from data accessible from other online marketplaces, e.g., an auction and/or fixed price system 202.

Similar as described above and shown by block 402, 404 and 406 of FIG. 4, an offered listing of goods to be bartered is received from a first user or potential seller by a first listing creation module 226 (block 504). A currency converter module 250 may access a database 126 containing online marketplace data relating to the current pricing of goods (shown by block 506) and may assign, as shown by block 508, a proprietary currency value to the goods of the offered listing to be bartered based on the current pricing of the goods.

A first listing management module 234 determines, as shown by block 508, whether the proprietary currency value assigned to the goods of the offered listing is equal to or above a predefined minimum value. For example, in order to ensure that barter users do not flood the barter system 200 with large number of goods with low value, a minimum value of the goods may be defined in terms of the proprietary currency. In the example embodiment where the conversion between the current pricing and proprietary currency is 2:1 the minimum value may be defined as 2 proprietary currency points (a value of approximately $4).

If particular goods in the offered listing received from the first user has a proprietary currency value assigned to them that is less than the predefined minimum value, the first listing management module 234 will reject the particular goods of the offered listing (shown by block 510). The first listing management module 234 may assess whether there remains goods on the offered listing that has a proprietary currency value above the predetermined threshold (block 512). If no such goods are listed on the offered listing, the first user will be given the option to offer new goods as part of an offered listing to be bartered (return to block 504).

If the first listing management module 234 determines that the goods, or at least some of the goods on the offered listing to be bartered, has been assigned a proprietary currency value above or equal to the predefined minimum value, the first listing management module 234 accepts the particular goods of the offered listing (block 514). This results in the listing of the offered goods on the online marketplace.

The barter system 200 may want to ensure that the proprietary currency value assigned to goods on the offered list is kept up to date with the current pricing of the same goods. This may be advantageous as goods may be on an offered listing in an online marketplace for extended periods of time, which may result in the initial proprietary currency value assigned to the goods becoming obsolete after a period of time. As shown by block 516 of FIG. 6, the currency converter module 250 may periodically access the database 126 to obtain an updated current pricing of the goods on the offered listing to be bartered. The currency converter module 250 may then assign an updated proprietary currency value to the goods on the offered listing based on the current pricing of the goods.

In order for goods to be bartered in an online marketplace, a second user, or potential buyer, needs to show interest in goods that may already be listed in an offered listing or in goods that may in time be listed on an offered listing. Returning to FIG. 5, block 518 shows that a desired listing of goods is received from a second user. The currency converter module 250, may now, in a similar fashion to assigning value to goods of offered listings, access the database 126, and in particular the current pricing table 320 maintained on the database 126, to obtain a current pricing of the goods of the desired listing to be bartered (block 520). The currency converter module 250 assigns a proprietary currency value to the goods of the desired listing based on the current pricing of the goods.

The second user or potential barter buyer would only be allowed to receive any bartered goods if the second user has sufficient proprietary currency in a proprietary currency account assigned to the second user. As shown by block 522, the second listing management module 236 determines whether the proprietary currency value assigned to the goods of the desired listing is equal to or above a proprietary currency value in the proprietary currency account of the second user. If the value of the second user's proprietary currency account is not sufficient to enable the second user to transact, the second user may either offer new goods to be bartered on an offered listing (returning to block 504) or the second user may alter the desired listing of goods, thereby to reduce the value of the goods to be bartered (returning to block 518).

To ensure that the proprietary currency value of goods on the desired listing is up to date, the currency converter module 250 may periodically access the database 126 to obtain an updated current pricing of the goods of the desired listing to be bartered and may assign an updated proprietary currency value to the goods of the desired listing based on the current pricing of the goods (shown by block 526 in FIG. 6).

In order for goods to be transacted, a barter transaction module 252 matches goods of the offered listing received from the first user and accepted by as goods having an assigned proprietary currency value equal to or above the predefined minimum value to goods of the desired listing received from the second user (block 528). For example, the barter transaction module 252 matches an offering of a “Ice Age” DVD by the first user to a request on the desired listing of the second user for the “Ice Age” DVD.

In some example embodiments, and as shown by block 530, the barter system 200 may provide functionality to adjust the assigned proprietary currency value of matched goods prior to crediting or debiting proprietary currency accounts belonging to the first and second user. For example, the assigned proprietary currency value may be adjusted based on at least one of a group of conditions comprising a condition of the goods, a location of the goods, a price of shipping the goods, profile data of the first or second user or a time-to-ship period associated with the first user. In the event that the condition of the goods on offer is poor, the proprietary currency value may be reduced. The profile data of the users and the time-to-ship period associated with the first user may be important criteria to take into account when adjusting the proprietary currency value of the goods to be bartered, as these criteria provide an incentive for users to ensure that their profiles are positive and that they have a short period to ship.

Once the proprietary currency value of the goods to be bartered has been adjusted, the proprietary currency account module 254 credits the proprietary currency account of the first user and debits the proprietary currency account of the second user with the proprietary currency value assigned to the matched goods (block 532).

The first user will now arrange to send the offered goods to the second user, thereby concluding the barter transaction.

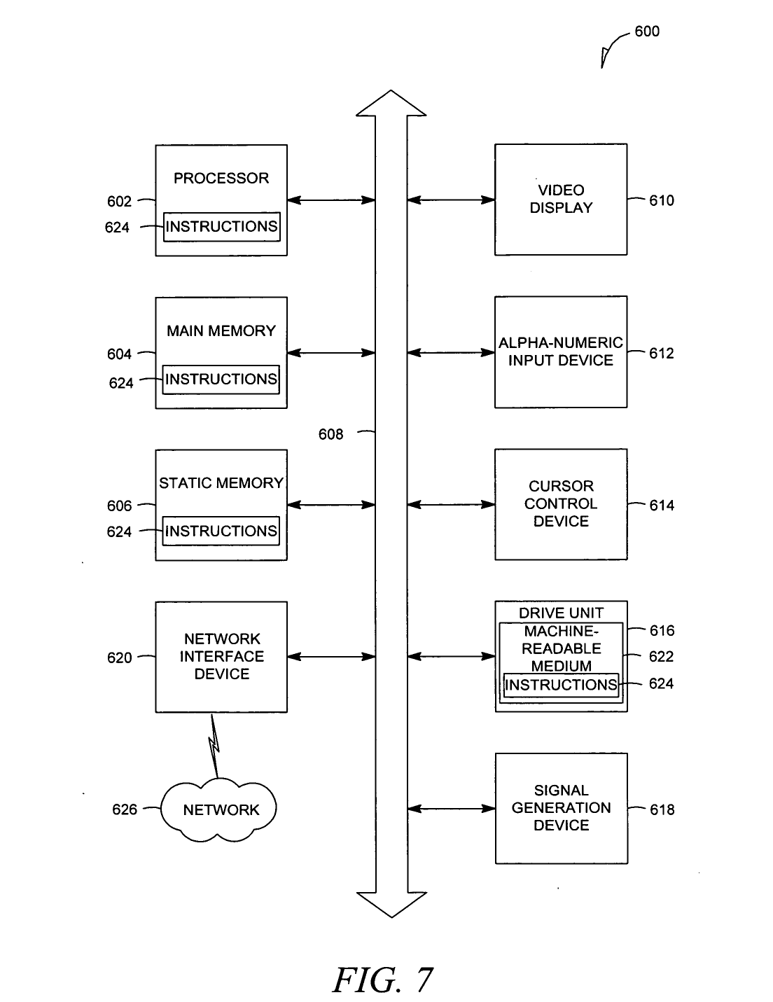

FIG. 7 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to assign a proprietary currency value to goods to be bartered, the proprietary currency value linked to the current pricing of the goods have been described. Although the present disclosure has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a first listing creation module to receive from a first user an offered listing of goods to be bartered;
a database containing online marketplace data relating to a current pricing of goods; and
a currency converter module to access the database to obtain the current pricing of the goods of the offered listing to be bartered and to assign a proprietary currency value to the goods on the offered listing based on the current pricing of the goods, the currency converter module further being to access the database periodically to obtain an updated current pricing of the goods on the offered listing to be bartered and to dynamically assign an updated proprietary currency value to the goods on the offered listing based on the current pricing of the goods.

2. The system of claim 1, further comprising a first listing management module to determine whether the proprietary currency value assigned to the goods of the offered listing is equal to or above a predefined minimum value.

3. The system of claim 2, wherein the first listing management module is to reject goods of the offered listing received from the first user if the proprietary currency value of the goods is below a predefined minimum value.

4. The system of claim 3, wherein the first listing management module is to accept goods of the offered listing received from the first user if the proprietary currency value of the goods is equal to or above a predefined minimum value.

5. The system of claim 1, wherein the currency converter module is to access the database to obtain the updated current pricing of the goods on the offered listing to be bartered and wherein the updated current pricing is based on auction pricing on an online marketplace.

6. The system of claim 4, further comprising a second listing creation module to receive from a second user a desired listing of goods.

7. The system of claim 6, wherein the currency converter module is to access the database to obtain a current pricing of the goods of the desired listing to be bartered and to assign a proprietary currency value to the goods of the desired listing based on the current pricing of the goods.

8. The system of claim 7, further comprising a second listing management module to determine whether the proprietary currency value assigned to the goods of the desired listing is equal to or above a proprietary currency value in a proprietary currency account of the second user.

9. The system of claim 7, wherein the currency converter module to access the database periodically to obtain an updated current pricing of the goods of the desired listing to be bartered and to assign an updated proprietary currency value to the goods of the desired listing based on the current pricing of the goods.

10. The system of claim 8, comprising:
a barter transaction module to match goods of the offered listing received from the first user and accepted by the first listing management module to goods of the desired listing received from the second user.

11. The system of claim 10, comprising:
a proprietary currency account module to credit a proprietary currency account of the first user and debit the proprietary currency account of the second user with the proprietary currency value assigned to the matched goods by the currency converter module.

12. The system of claim 11, wherein the currency converter module is to adjust the assigned proprietary currency value for the matched goods, prior to crediting or debiting the proprietary currency accounts, based on at least one of a group of conditions consisting of a condition of the goods to be bartered, a location of the goods to be bartered, profile data of the first user or a time-to-ship period associated with the first or second user, and a system provider charge

13. A method comprising:
receiving from a first user an offered listing of goods to be bartered;
accessing a database containing online marketplace data relating to the current pricing of goods;
assigning a proprietary currency value to the goods of the offered listing to be bartered based on the current pricing of the goods; and
periodically accessing the database to obtain an updated current pricing of the goods on the offered listing to be bartered and assigning an updated proprietary currency value to the goods on the offered listing based on the current pricing of the goods.

14. The method of claim 13, comprising determining whether the proprietary currency value assigned to the goods of the offered listing is equal to or above a predefined minimum value.

15. The method of claim 14, comprising, rejecting, in response to determining that the proprietary currency value assigned to particular goods of the offered listing is less than the predefined minimum value, the particular goods of the offered listing.

16. The method of claim 15, comprising, accepting, in response to determining that the proprietary currency value assigned to particular goods of the offered listing is equal to or more than the predefined minimum value, the particular goods of the offered listing.

17. The method of claim 16, comprising accessing the database to obtain an updated current pricing of the goods on the offered listing to be bartered and determining the updated proprietary currency value based on auction pricing on an online marketplace.

18. The method of claim 16, comprising receiving a desired listing of goods from a second user.

19. The method of claim 18, comprising accessing the database to obtain a current pricing of the goods of the desired listing to be bartered and assigning a proprietary currency value to the goods of the desired listing based on the current pricing of the goods.

20. The method of claim 19, further comprising determining whether the proprietary currency value assigned to the goods of the desired listing is equal to or above a proprietary currency value in a proprietary currency account of the second user.

21. The method of claim 20, comprising accessing the database periodically to obtain an updated current pricing of the goods of the desired listing to be bartered and assigning an updated proprietary currency value to the goods of the desired listing based on the current pricing of the goods.

22. The method of claim 20, comprising matching goods of the offered listing received from the first user and accepted by as goods having an assigned proprietary currency value equal to or above a predefined minimum value to goods desired of the desired listing received from the second user.

23. The method of claim 22, comprising crediting a proprietary currency account of the first user and debiting the proprietary currency account of the second user with the proprietary currency value assigned to the matched goods.

24. The method of claim 23, comprising adjusting, prior to crediting or debiting the proprietary currency accounts, the assigned proprietary currency value for the matched goods, based on at least one of a group of conditions comprising a condition of the goods, a location of the goods, a price of shipping the goods, profile data of the first or second user or a time-to-ship period associated with the first user.

25. A system comprising:
first means for receiving from a first user an offered listing of goods to be bartered;
second means for containing online marketplace data relating to a current pricing of goods; and
third means for accessing the database to obtain the current pricing of the goods on the offered listing to be bartered and for assigning a proprietary currency value to the goods on the offered listing based on the current pricing of the goods, the third means for accessing the database periodically to obtain an updated current pricing of the goods on the offered listing to be bartered and for dynamically assigning an updated proprietary currency value to the goods on the offered listing based on the current pricing of the goods.

26. The system of claim 25, further comprising fourth means for:
determining whether the proprietary currency value assigned to the goods of the offered listing is equal to or above a predefined minimum value;
rejecting goods of the offered listing received from the first user if the proprietary currency value of the goods is below a predefined minimum value; and
accepting goods of the offered listing received from the first user if the proprietary currency value of the goods is equal to or above a predefined minimum value.

27. The system of claim 26, further comprising fifth means for receiving a desired listing of goods from a second user.

28. The system of claim 27, comprising:
sixth means for matching goods of the offered listing received from the first user and accepted by the first listing management module to goods of the desired listing received from the second user.

29. The system of claim 28, comprising:
seventh means for crediting a proprietary currency account of the first user and debiting the proprietary currency account of the second user with the proprietary currency value assigned to the matched goods by the currency converter module.

30. A machine-readable medium embodying a set of instructions to perform the method of claim 13.
